(19) United States
(12) Patent Application Publication
(10) Pub. No.: US 2004/0083868 A1
(43) Pub. Date: May 6, 2004

(54) Cutting device

(76) Inventor: Naoki Ohmiya, Tokyo (JP)

Correspondence Address: Smith Gambrell & Russell, Suite 800, 1850 M Street NW, Washington, DC, 20036, US

(21) Appl. No.: 10/469,289

(22) PCT Filed: Jan. 9, 2003
(86) PCT No.: PCT/JP03/00100

(30) Foreign Application Priority Data
Jan. 18, 2002 (JP) 2002-9759

(51) Int. Cl. B26D 7/06

(52) U.S. Cl. 83/168; 83/929.1; 83/99

(57) ABSTRACT

A cutting machine equipped with a chuck table for holding a workpiece, a cutting means having a cutting blade for cutting the workpiece held on the chuck table, and a cutting blade detector having a light emitting portion and a light receiving portion for detecting the state of the cutting blade, wherein the cutting blade detector comprises a protective cover means for selectively covering the light emitting portion and the light receiving portion.

### TECHNICAL FIELD

The present invention relates to a cutting machine having a cutting blade for cutting a workpiece such as a semiconductor wafer and, specifically, to a cutting machine which comprises a blade sensor having a light emitting portion and a light receiving portion for detecting the state of a cutting blade.

### BACKGROUND ART

In the production process of semiconductor devices, for example, semiconductor chips are produced by forming a circuit such as IC, LSI or the like in a large number of areas arranged in a lattice form on the surface of a substantially disk-like semiconductor wafer and dicing the areas having circuit formed, along predetermined streets (cutting lines). A cutting machine is generally used as a machine for dicing a semiconductor wafer. The cutting machine for dicing a semiconductor wafer is equipped with a chuck table for holding a workpiece and a cutting means having a cutting blade for cutting the workpiece held on the chuck table. The cutting machine equipped with the cutting means having a cutting blade is further provided with a cutting blade detector for detecting the position of the cutting blade in order to adjust the cutting depth of the cutting blade.

In the above cutting machine for cutting a workpiece with the cutting blade, cutting water is supplied to an area at which the cutting blade and the workpiece come into contact at the time when the workpiece is cut. Therefore, this cutting water containing chippings is scattered and adhered to the cutting blade detector. And, since the cutting blade detector generally comprises a light emitting element and a light receiving element, this causes a problem that the amount of received light changes due to adhesion of cutting water containing chippings to the cutting blade detector, thereby making it impossible to detect the position of the cutting blade accurately.

The present invention has been made in view of the above fact, and its principal object is, therefore, to provide a cutting machine which prevents cutting water which is scattered during cutting from adhering to the light emitting portion and light receiving portion of a cutting blade detector and enables the cutting blade detector to always detect the state of the cutting blade accurately.

### DISCLOSURE OF THE INVENTION

To attain the above principal object, according to the present invention, there is provided a cutting machine that is equipped with a chuck table for holding a workpiece, a cutting means having a cutting blade for cutting the workpiece held on the chuck table, and a cutting blade detector having a light emitting portion and a light receiving portion for detecting the state of the cutting blade, wherein

the cutting blade detector comprises a protective cover means for selectively covering the light emitting portion and the light receiving portion.

The above cover means comprises a cover which is moved to a close position where the light emitting portion and the light receiving portion are covered and to an open position where the light emitting portion and the light receiving portion are exposed and a drive means for moving the cover to a close position and an open position, and the drive means positions the cover at a close position at least when cutting is carried out using the cutting blade and at an open position at least when the cutting blade is detected.

The above cutting blade detector comprises cleaning water supply nozzles for supplying cleaning water to the light emitting portion and the light receiving portion and air supply nozzles for supplying air to the light emitting portion and the light receiving portion, and the above cover is constituted to cover the cleaning water supply nozzles and the air supply nozzles when it is positioned at a close position.

### BRIEF DESCRIPTION OF THE DRAWINGS

FIG. 1 is a perspective view of a cutting machine constituted according to the present invention;

FIG. 2 is a perspective view of the important section of the cutting machine shown in FIG. 1;

FIG. 3 is a simplified diagram for explaining a first spindle unit and a second spindle unit constituting the cutting machine shown in FIG. 1;

FIG. 4 is a perspective view of a cutting blade detector mounted to the cutting machine shown in FIG. 1; and

FIG. 5 is a perspective view showing that the protective cover means of the cutting blade detector shown in FIG. 4 is in a closed state.

### BEST MODE FOR CARRYING OUT THE INVENTION

A preferred embodiment of a cutting machine constituted according to the present invention will be described in detail with reference to the accompanying drawings.

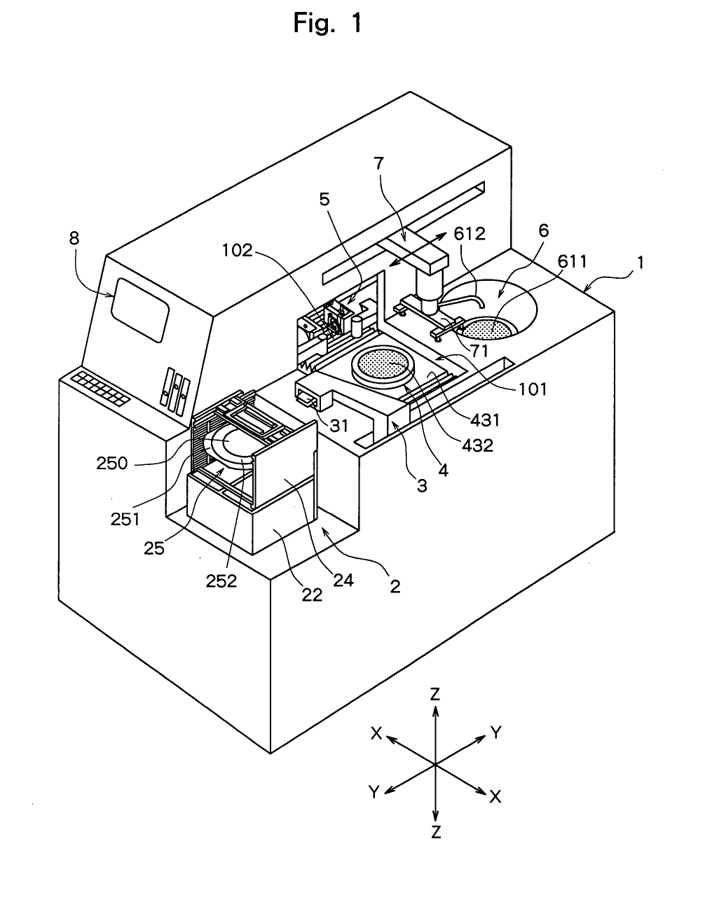

FIG. 1 is a perspective view of a cutting machine constituted according to the present invention. The dicing machine shown in FIG. 1 comprises a substantially rectangular parallelepiped machine housing 1. The machine housing 1 incorporates a cassette unit 2 for storing a semiconductor wafer as a workpiece, a workpiece carrying-in/carrying-out means 3 for carrying out the workpiece stored in the cassette unit 2 and carrying the workpiece after cutting into the cassette unit 2, a chuck table unit 4 for holding the workpiece taken out by the workpiece carrying-in/carrying-out means 3, a cutting means 5 for cutting the workpiece held on the chuck table unit 4, a cleaning means 6 for cleaning the workpiece cut by the cutting means 5, and a workpiece conveying means 7 for carrying the workpiece between the chuck table unit 4 and the cleaning means 6. Further, a monitor 8 for displaying an image taken by an optical means which will be described later is also disposed in the machine housing 1.

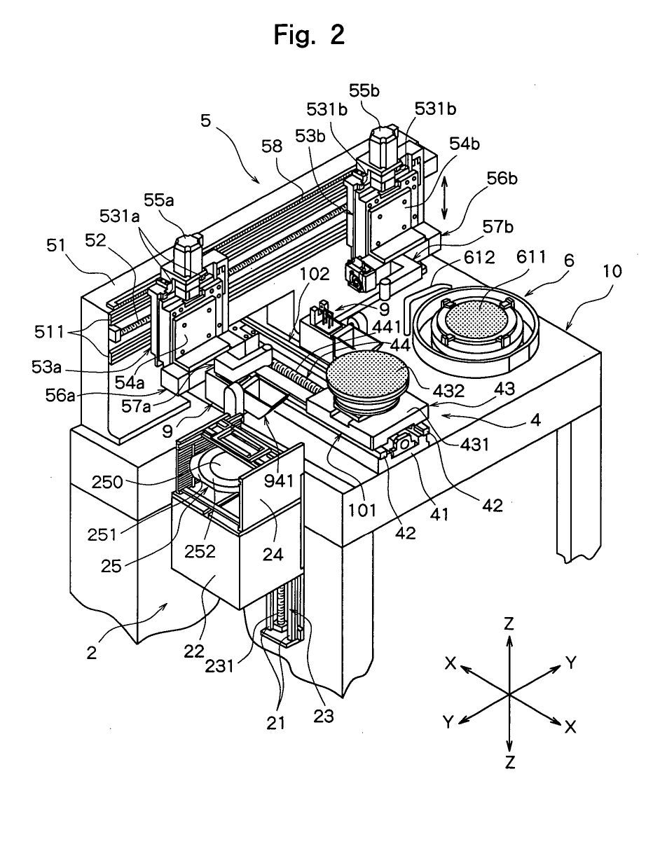

The above cassette unit 2, chuck table unit 4 and cutting means 5 will be described with reference to FIG. 2.

The dicing machine of the illustrated embodiment comprises a stationary base 10, installed in the housing 1, for mounting the above means and units. The above cassette unit 2 comprises a cassette table 22 which can be slidably moved along two guide rails 21 and 21 provided on the side face of the stationary base 10 in a vertical direction and a drive means 23 for moving the cassette table 22 along the guide rails 21 in the vertical direction (direction shown by an arrow Z). The drive means 23 includes a male screw rod 231 arranged between the two guide rails 21 and 21 and in parallel to the guide rails 21 and 21, a female screw block (not shown) mounted to the cassette table 22 and screwed to the male screw rod 231, and a drive source such as a pulse motor, etc. (not shown) for rotationally driving the male screw rod 231. Therefore, the cassette table 22 is moved in the vertical direction (direction shown by the arrow Z) by turning the male screw rod 231 by the pulse motor that is not shown,. Thus, a cassette 24 having a plurality of storage chambers is placed on the cassette table 22 which is movable in the vertical direction. The workpieces 25 are each stored in the plurality of the storage chambers of the cassette 24. In the illustrated embodiment, a semiconductor wafer 250 mounted to an annular frame 251 by a tape 252 is shown as the workpiece 25.

The above chuck table unit 4 comprises a support base 41 fixed on the stationary base 10, two guide rails 42 and 42 arranged on the support base 41 and in parallel to each other in the direction shown by an arrow X, and a chuck table 43 as a workpiece holding means for holding the workpiece, which is mounted on the guide rails 42 and 42 in such a manner that it can move in the direction shown by the arrow X. The chuck table 43 has an adsorption chuck base 431 movably mounted on the guide rails 42 and 42 and an adsorption chuck 432 mounted on the adsorption chuck base 431, and a disk-like semiconductor wafer 250 as the workpiece is held on the adsorption chuck 432 by a suction means that is not shown. The chuck table unit 4 has a drive means 44 for moving the chuck table 43 along the two guide rails 42 and 42 in the direction shown by the arrow X. The drive means 44 includes a male screw rod 441 arranged between the two guide rails 42 and 42 and in parallel to the guide rails 42 and 42, a female screw block (not shown) which is mounted to the adsorption chuck base 431 and screwed to the male screw rod 441, and a drive source such as a pulse motor (not shown) for rotationally driving the male screw rod 441. Therefore, the chuck table 43 is moved in the direction shown by the arrow X by turning the male screw rod 441 by the pulse motor that is not shown. That is, the chuck table 43 can be moved between a workpiece placing area 101 and a cutting area 102 shown in FIG. 1 and FIG. 2. The chuck table unit 4 has a rotation means (not shown) for turning the adsorption chuck 432.

A description is given of the above cutting means 5.

The cutting means 5 comprises a gate-like support base 51 fixed on the above stationary base 10. This gate-like support base 51 lies across the above cutting area 102. Two guide rails 511 and 511 are provided on the side wall of the support base 51 in such a manner that they are arranged in parallel to each other in the direction shown by an arrow Y, and one male screw rod 52 is fixedly disposed between the two guide rails 511 and 511 and in parallel to the guide rails 511 and 511. A first base 53a and a second base 53b are slidably provided along the guide rails 511 and 511 in the direction shown by the arrow Y. The first base 53a and the second base 53b are each fitted with a drive female screw block (not shown) to be screwed to the above common male screw rod 52. When the drive female screw blocks are moved by drive sources such as a pulse motor (not shown), the first base 53a and the second base 53b can be moved along the guide rails 511 and 511 in the direction shown by the arrow Y. Independent male screw rods may be provided for the first base 53a and the second base 53b and turned by a pulse motor or the like to move the first base 53a and the second base 53b in the direction shown by the arrow Y, respectively.

A pair of guide rails 531a and a pair of guide rails 531b are respectively provided on the first base 53a and the second base 53b in the cutting feed direction shown by an arrow Z, and a first suspension bracket 54a and a second suspension bracket 54b are respectively provided on the first base 53a and the second base 53b in such a manner that they can slide along the guide rails 531a and 531b in the cutting feed direction shown by the arrow Z. The first base 53a and the second base 53b are respectively provided with male screw rods (not shown) which are turned by drive sources such as pulse motors 55a and 55b, and the first suspension bracket 54a and the second suspension bracket 54b are respectively provided with female screw blocks to be screwed to the above male screw rods. Therefore, the first suspension bracket 54a and the second suspension bracket 54b can be moved along the guide rails 531a and 531b in the cutting feed direction shown by the arrow Z perpendicular to the workpiece holding surface 432a of the above adsorption chuck 432 by turning the male screw rods (not shown) by the pulse motors 55a and 55b.

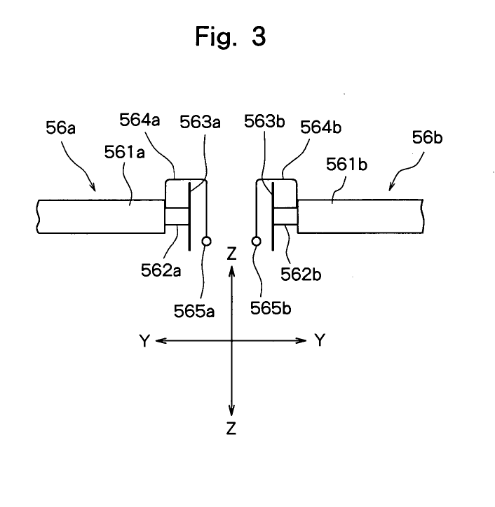

A first spindle unit 56a as a first cutting means and a second spindle unit 56b as a second cutting means are mounted to the first suspension bracket 54a and the second suspension bracket 54b, respectively. The first spindle unit 56a and the second spindle unit 56b will be described with reference to FIG. 3, in which they are simplified. The first spindle unit 56a and the second spindle unit 56b comprise a first spindle housing 561a and a second spindle housing 561b each fixed to the first suspension bracket 54a and the second suspension bracket 54b, a first rotary spindle 562a and a second rotary spindle 562b each rotatably supported to the first spindle housing 561a and the second spindle housing 561b, and a first cutting blade 563a and a second cutting blade 563b attached to the respective one end portion of the first rotary spindle 562a and the second rotary spindle 562b. The thus constituted first spindle unit 56a and second spindle unit 56b are arranged in such a manner that the first cutting blade 563a and the second cutting blade 563b are opposed to each other. That is, the first spindle unit 56a and the second spindle unit 56b are arranged on one straight line so that their axes are directed toward the indexing direction shown by the arrow Y. A first blade cover 564a for covering upper half portion of the first cutting blade 563a and a second blade cover 564b for covering upper half portion of the second cutting blade 563b are respectively mounted to end portions, which are opposed to each other, of the first spindle housing 561a and the second spindle housing 561b, and a first cutting water supply nozzle 565a and a second cutting water supply nozzle 565b for supplying cutting water are attached to the first blade cover 564a and the second blade cover 564b, respectively. The thus constituted first spindle unit 56a and second spindle unit 56b are provided with a first optical means 57a and a second optical means 57b such as a microscope or CCD camera as shown in FIG. 2, respectively. The first optical means 57a is fixed to the first spindle housing 561a and the second optical means 57b is fixed to the second spindle housing 561b.

The cutting operation of the above cutting machine will be briefly described with reference to FIG. 1 and FIG. 2.

First, the cassette 24 placed on the cassette table 22 is positioned at a suitable height by activating the drive means 23 of the cassette unit 2. When the cassette 24 is positioned at a suitable height, the workpiece carrying-in/carrying-out means 3 is activated to take out a workpiece stored in the cassette 24 with a gripping member 31 and place it on the adsorption chuck 432 of the chuck table unit 4 positioned in the workpiece placing area 101. The workpiece 25 placed on the adsorption chuck 432 is suction-held on the adsorption chuck 432 by an adsorption means that is not shown. When the workpiece 25 is thus suction-held on the adsorption chuck 432, the chuck table 43 is moved in the direction shown by the arrow X, and the first base 53a and the second base 53b fitted with the first suspension bracket 54a and the second suspension bracket 54b mounting the first spindle unit 56a and the second spindle unit 56b are moved in the Y direction to position the workpiece 25 placed on the workpiece holding surface 432a of the adsorption chuck 432 right below the first optical means 57a and the second optical means 57b as shown in FIG. 2, respectively. The surface of the semiconductor wafer 250 as the workpiece 25 is imaged by the first optical means 57a and the second optical means 57b to detect at least one of the streets (cutting lines) formed on the surface of the semiconductor wafer 250 so that the detected cutting lines are respectively aligned with the first cutting blade 563a and the second cutting blade 563b in the Y direction. On this occasion, in the illustrated embodiment, the positions in the Y direction of the first base 53a and the second base 53b are precision controlled based on a measurement value obtained by one linear scale 58 provided on the support base 51. In the illustrated embodiment, since only one linear scale is shared by the first base 53a and the second base 53b, position control in the Y direction is carried out with the same scale, thereby making it possible to improve accuracy as compared with a case where scales are separately provided. Since the first optical means 57a and the second optical means 57b are respectively provided for the first spindle unit 56a and the second spindle unit 56b in the illustrated embodiment, the alignment works in the Y direction of the first cutting blade 563a and the second cutting blade 563b can be carried out at the same time efficiently.

Thereafter, the first suspension bracket 54a supporting the first spindle unit 56a and the second suspension bracket 54b supporting the second spindle unit 56b are lowered to the cutting position, and the chuck table 43 suction-holding the semiconductor wafer 250 is moved to the cutting area 102 in the X direction which is the cutting feed direction, whereby the semiconductor wafer 250 subjected to the action of the first cutting blade 563a and the second cutting blade 563b which rotate at a high speed is cut along the cutting lines detected as described above. During cutting, cutting water is supplied from the first cutting water supply nozzle 565a and the second cutting water supply nozzle 565b to cutting portions, that is, the contact area between the first cutting blade 563a and the semiconductor wafer 250 and the contact area between the second cutting blade 563b and the semiconductor wafer 250. The movements in the indexing direction shown by the arrow Y of the first base 53a and the second base 53b fitted with the first suspension bracket 54a and the second suspension bracket 54b mounting the first spindle unit 56a and the second spindle unit 56b, respectively, and the movement in the cutting feed direction shown by the arrow X of the chuck table 43 suction-holding the semiconductor wafer 250 are thus carried out repeatedly to cut the semiconductor wafer 250 along a plurality of cutting lines formed in the semiconductor wafer 250 successively. When cutting along all cutting lines having the same direction formed in the semiconductor wafer 250 is over, the adsorption chuck 432 suction-holding the semiconductor wafer 250 is turned at 90° to carry out the same cutting work as described above, whereby the semiconductor wafer 250 is cut along all the cutting lines formed in a lattice in the semiconductor wafer 250 to form individual pellets.

After the cutting work is over as described above, the chuck table 43 positioned in the cutting area 102 shown in FIG. 1 is moved to the workpiece placing area 101. After the chuck table 43 is positioned in the workpiece placing area 101, the workpiece conveying means 7 is activated to adsorb the frame 251 mounting the semiconductor wafer 250 held on the chuck table 43 to an adsorption pad 71 and carry it onto the spinner table 611 of the cleaning means 6. The cut semiconductor wafer 250 carried onto the spinner table 611 is cleaned with a jet of cleaning water supplied from a cleaning water supply nozzle 612 to remove chippings and dried by centrifugal force produced by the rotation of the spinner table 611. After the semiconductor wafer 250 is thus cleaned, the workpiece conveying means 7 is activated to adsorb the frame 251 mounting the semiconductor wafer 250 to the adsorption pad 71 and place it on the adsorption chuck 432 of the chuck table 43 positioned in the workpiece placing area 101. The workpiece carrying-in/carrying-out means 3 is then activated to store the cleaned semiconductor wafer 250 and the frame 251 placed on the adsorption chuck 432 in a predetermined storage chamber of the cassette 24.

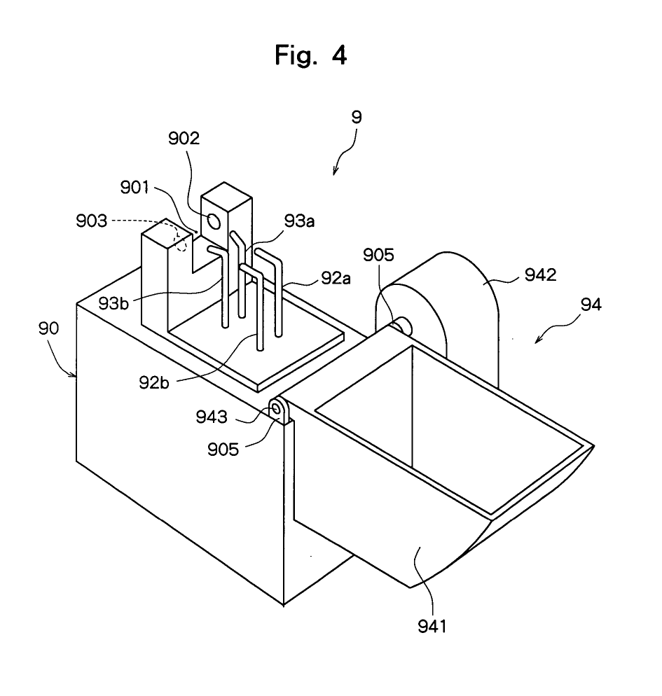

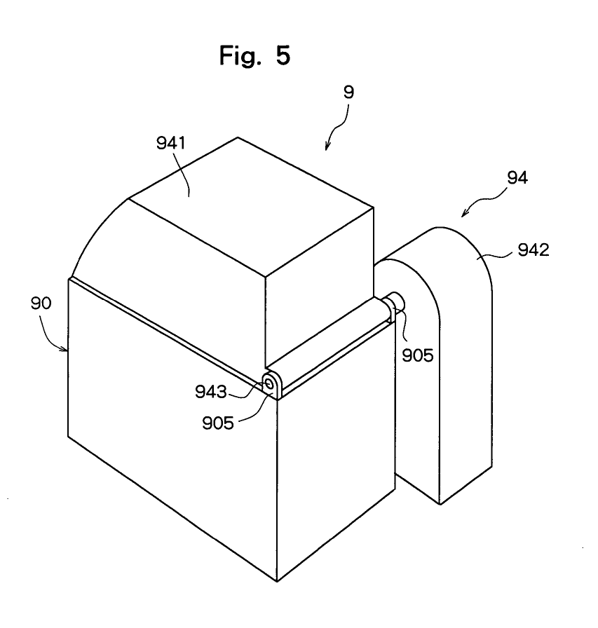

The cutting machine of the illustrated embodiment comprises cutting blade detectors 9 and 9 for detecting the reference positions in the cutting direction of the cutting blades in order to adjust the cutting depths of the first cutting blade 563a and the second cutting blade 563b in relation to the first spindle unit 56a as the first cutting means and the second spindle unit 56b as the second cutting means. The cutting blade detectors 9 and 9 provided for the first spindle unit 56a and the second spindle unit 56b are substantially the same in constitution. The cutting blade detector 9 will be described with reference to FIG. 4 and FIG. 5. The cutting blade detector 9 comprises a detector body 90 having a blade entry portion 901 to which the peripheral portion of the first cutting blade 563a or the second cutting blade 563b enters. The detector body 90 is arranged on the traveling line in the indexing direction shown by the arrow Y of the first cutting blade 563a or the second cutting blade 563b on the above stationary base 10. In the detector body 90, a light emitting portion 902 and a light receiving portion 903 are provided opposed to each other, in the blade entry portion 901. The light emitting portion 902 is connected to a light source (not shown) via an optical fiber to emit light from the light source toward the light receiving portion 903. The light receiving portion 903 receives light emitted from the light emitting portion 902 and sends its received light to a photoelectric conversion portion (not shown) via an optical fiber. The thus constituted cutting blade detector 9 detects the amount of light received by the light receiving portion 903 in a state of the peripheral portion of the cutting blade entering the blade entry portion 901 to detect the reference position in the cutting direction of the cutting blade.

The cutting blade detector 9 of the illustrated embodiment has cleaning water supply nozzles 92a and 92b for supplying cleaning water to the end faces of the light emitting portion 902 and the light receiving portion 903, and air supply nozzles 93a and 93b for supplying air to the end faces of the light emitting portion 902 and the light receiving portion 903. The cleaning water supply nozzles 92a and 92b and the air supply nozzles 93a and 93b are arranged such that the openings of the air supply nozzles 93a and 93b are adjacent to the light emitting portion 902 and the light receiving portion 903 and the openings of the cleaning water supply nozzles 92a and 92b are situated behind the air supply nozzles 93a and 93b in the illustrated embodiment, respectively. The cleaning water supply nozzles 92a and 92b are connected to a cleaning water supply source by a flexible hose (not shown) and the air supply nozzles 93a and 93b are connected to a compressed air supply source by a flexible hose (not shown).

The cutting blade detector 9 in the illustrated embodiment has a protective cover means 94 for selectively covering the above light emitting portion 902 and the light receiving portion 903, the cleaning water supply nozzles 92a and 92b, and the air supply nozzles 93a and 93b. The protective cover means 94 comprises a cover 941 and an air motor 942 as a drive means for opening or closing the cover 941. A turn shaft 943 is attached to one end of the cover 941 and turnably supported to support brackets 905 and 905 provided at both end portions of the detector body 90. The drive shaft of the air motor 942 is connected to the above turn shaft 943 to drive the turn shaft 943 in one direction or the other direction in order to move the cover 941 to an open position where the light emitting portion 902, the light receiving portion 903, the cleaning water supply nozzles 92a and 92b and the air supply nozzles 93a and 93b are exposed as shown in FIG. 4 and to a close position where the light emitting portion 902, the light receiving portion 903, the cleaning water supply nozzles 92a and 92b and the air supply nozzles 93a and 93b are selectively covered as shown in FIG. 5. This air motor 942 is connected to an air control circuit (not shown) and positions the cover 941 at a close position shown in FIG. 5 at least when the above-described cutting is carried out and at an open position shown in FIG. 4 at least when the reference position of the cutting blade is detected. Therefore, if cutting water containing chippings to be supplied to the cutting work portion at the time of cutting is scattered, it will not adhere to the light emitting portion 902 and the light receiving portion 903 of the cutting blade detector 9, thereby making it possible to detect the state of the cutting blade accurately at the time when the reference position of the cutting blade is detected.

In the cutting blade detector 9 in the illustrated embodiment, the cleaning of the light emitting portion 902 and the light receiving portion 903 is carried out when the cover 941 of the protective cover means 94 is positioned at a close position shown in FIG. 5, that is, at the time of cutting. When the reference position of the cutting blade is to be detected, the cover 941 is positioned at an open position, cleaning water is further supplied to the light emitting portion 902 and the light receiving portion 903 from the cleaning water supply nozzles 92a and 92b to clean them, and after the supply of cleaning water is stopped, air is supplied to the light emitting portion 902 and the light receiving portion 903 from the air supply nozzles 93a and 93b to dry the light emitting portion 902 and the light receiving portion 903 so that the light emitting portion 902 and the light receiving portion 903 are in an extremely good condition when the reference position of the cutting blade is detected.

As described above, the present invention has been described with reference to the illustrated embodiment, but the present invention is not limited thereto. That is, in the illustrated embodiment, the present invention is applied to a cutting machine having two cutting means. When the present invention is applied to a cutting machine having only one cutting means which is generally used, the same effect and function can be obtained.

### Industrial Utilization Feasibility

Since the cutting machine according to the present invention is constituted as described above, it provides the following function and effect.

That is, according to the present invention, since a cutting blade detector having a light emitting portion and a light receiving portion, for detecting the state of a cutting blade comprises a protective cover means for selectively covering the light emitting portion and the light receiving portion, the light emitting portion and the light receiving portion are covered by the protective cover means during cutting, whereby if cutting water containing chippings, supplied to the cutting work portion is scattered, it does not adhere to the light emitting portion and the light receiving portion, thereby making it possible to detect the state of the cutting blade accurately at the time when the cutting blade is detected.

1. A cutting machine equipped with a chuck table for holding a workpiece, a cutting means having a cutting blade for cutting the workpiece held on the chuck table, and a cutting blade detector having a light emitting portion and a light receiving portion for detecting the state of the cutting blade, wherein
the cutting blade detector comprises a protective cover means for selectively covering the light emitting portion and the light receiving portion.

2. The cutting machine according to claim 1, wherein the protective cover means comprises a cover which is moved to a close position where the light emitting portion and the light receiving portion are covered and to an open position where the light emitting portion and the light receiving portion are exposed and a drive means for moving the cover to a close position and open position, and the drive means positions the cover at a close position at least when cutting is carried out using the cutting blade and at an open position when the cutting blade is detected.

3. The cutting machine according to claim 1, wherein the cutting blade detector comprises a cleaning water supply nozzle for supplying cleaning water to the light emitting portion and the light receiving portion and an air supply nozzle for supplying air to the light emitting portion and the light receiving portion, and the cover is constituted to cover the cleaning water supply nozzle and the air supply nozzle when it is positioned at a close position.
